(19) United States
(12) Patent Application Publication
(10) Pub. No.: US 2020/0108826 A1
(43) Pub. Date: Apr. 9, 2020

(54) APPARATUS, METHOD AND SYSTEM OF CONTROLLING DRIVING OF VEHICLE

(71) Applicant: MANDO CORPORATION, Pyeongtaek-si (KR)

(72) Inventor: Nayoung KIM, Seongnam-si (KR)

(73) Assignee: MANDO CORPORATION, Pyeongtaek-si (KR)

(21) Appl. No.: 16/595,744

(22) Filed: Oct. 8, 2019

(30) Foreign Application Priority Data
Oct. 8, 2018 (KR) 10-2018-0120075

(51) Int. Cl. B60W 30/095; B60W 30/09; G05D 1/02; G08G 1/005; G08G 1/01

(52) U.S. Cl. CPC B60W 30/0956; B60W 30/09; G05D 1/0214; G05D 1/0223; G06T 2207/30261; G05D 1/0257; G08G 1/005; G08G 1/0104; G05D 1/0246

(57) ABSTRACT

The disclosure provides an apparatus, method and system for assisting driving of a vehicle including an image sensor disposed in the vehicle to have a field of view of the front of the vehicle, configured to capture image data, a radar disposed in the vehicle to have a detecting area the outside of the vehicle, configured to capture detecting data to detect an object around the vehicle, and a controller including at least one processor configured to process the image data captured by the image sensor and the detecting data captured by the radar. The controller may obtain state information of vehicle traffic lights based on processing of the image data, in response to a right turn operation is detected at an intersection, and may control the vehicle to turn right after pausing or decelerating at a predetermined speed based on the state information of the vehicle traffic lights, information about another vehicle of a left lane detected based on processing of the detecting data, and state information of crosswalk traffic lights received from an external device. According to the disclosure it is possible to perform a right turn more safely at the intersection.

### CROSS-REFERENCE TO RELATED APPLICATION(S)

This application is based on and claims priority under 35 U.S.C. § 119 to Korean Patent Application No. 10-2018-0120075, filed on Oct. 8, 2018 in the Korean Intellectual Property Office, the disclosure of which is incorporated by reference in its entirety.

### TECHNICAL FIELD

Embodiments of the disclosure relate to a method of controlling driving of a vehicle based on information around the vehicle at an intersection.

### BACKGROUND

When vehicle traffic lights turn red at the intersection, a vehicle must turn right according to crosswalk traffic lights after stopping at a stop line in front of the crosswalk, even if the vehicle turns right. In this case, an accident with a pedestrian may occur when the vehicle is turned right due to the stop line failure, a violation of a pedestrian signal in a crosswalk, or the inability to secure a view due to another vehicle in a left stop lane.

In addition, even in the crosswalk after a right turn, the pedestrian safety is threatened because the vehicle is turned right without slowing down or obscuring visibility, making it impossible to check the presence of the pedestrian. Therefore, in order to reduce the accident with the pedestrian that may occur during a right turn, it is necessary to appropriately control driving of the vehicle according to a state of the vehicle traffic lights during the right turn.

### SUMMARY

Therefore, it is an aspect of the disclosure to provide a driving control apparatus of a vehicle capable of performing a right turn more safely in an intersection by controlling the driving of a vehicle during a right turn according to state information of vehicle traffic lights, information of another vehicle, and state information of crosswalk traffic lights, and a method and a system thereof.

Additional aspects of the disclosure will be set forth in part in the description which follows and, in part, will be obvious from the description, or may be learned by practice of the disclosure.

In accordance with an aspect of the disclosure, an apparatus for assisting driving of a vehicle includes: an image sensor disposed in the vehicle to have a field of view of the front of the vehicle, configured to capture image data; a radar disposed in the vehicle to have a detecting area the outside of the vehicle, configured to capture detecting data to detect an object around the vehicle; and a controller including at least one processor configured to process the image data captured by the image sensor and the detecting data captured by the radar. The controller may obtain state information of vehicle traffic lights based on processing of the image data, in response to a right turn operation is detected at an intersection; and may control the vehicle to turn right after pausing or decelerating at a predetermined speed based on the state information of the vehicle traffic lights, information about another vehicle of a left lane detected based on processing of the detecting data, and state information of crosswalk traffic lights received from an external device.

In accordance with another aspect of the disclosure, a method for assisting driving of a vehicle includes: obtaining image data through a camera disposed in the vehicle to have a field of view of the outside of the vehicle; obtaining detecting data through a radar disposed in the vehicle to have a detecting area of the outside of the vehicle; detecting a right turn operation at an intersection; obtaining state information of vehicle traffic lights based on processing of the image data; obtaining information about another vehicle of a left lane detected based on processing of the detecting data; receiving state information of crosswalk traffic lights from a communication device of the outside of the vehicle; and controlling the vehicle to turn right after pausing or decelerating at a predetermined speed based on the state information of the vehicle traffic lights, the information about the another vehicle, and the state information of the crosswalk traffic lights.

In accordance with another aspect of the disclosure, an apparatus for assisting driving of a vehicle includes: an image sensor disposed in the vehicle to have a field of view of the front of the vehicle, configured to capture image data; a radar disposed in the vehicle to have a detecting area the outside of the vehicle, configured to capture detecting data to detect an object around the vehicle; a domain control unit (DCU) configured to process the image data captured by the image sensor and the detecting data captured by the radar, and to control at least one driver assistance system provided in the vehicle. The DCU may obtain state information of vehicle traffic lights based on processing of the image data, in response to a right turn operation is detected at an intersection based on at least one of the image data and the detecting data; and may control the vehicle to turn right after pausing or decelerating at a predetermined speed based on the state information of the vehicle traffic lights, information about another vehicle of a left lane detected through the radar, and state information of crosswalk traffic lights received from an external device.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1A is a block diagram of a driving control apparatus of a vehicle according to embodiments of the disclosure;

FIG. 1B is a block diagram of a driving control apparatus of a vehicle provided with a domain control unit (DCU) according to embodiments of the disclosure;

FIGS. 2 to 6 are views for describing controlling right turn driving according to states of vehicle traffic lights, crosswalk traffic lights, and another vehicle in an intersection according to embodiments of the disclosure;

FIG. 7 is a block diagram of a driving control system of a vehicle according to embodiments of the disclosure;

FIG. 8 is a flowchart illustrating a driving control method of a vehicle according to embodiments of the disclosure;

FIG. 9 is a flowchart illustrating a method of controlling right turn driving when green is turned on in vehicle traffic lights according to embodiments of the disclosure;

FIG. 10 is a flowchart illustrating a method of controlling right turn driving when red or yellow are turned on in vehicle traffic lights according to embodiments of the disclosure; and

FIG. 11 is a flowchart illustrating a method of controlling right turn driving when an image is covered by another vehicle positioned in a left lane according to embodiments of the disclosure.

### DETAILED DESCRIPTION

Hereinafter, embodiments of the disclosure will be described in detail with reference to the accompanying drawings. Like reference numerals refer to like elements throughout this specification. This specification does not describe all components of the embodiments, and general contents in the technical field to which the disclosure belongs or overlapping contents between the embodiments will not be described.

It will be understood that, although the terms first, second, A, B, (a), (b) etc. may be used herein to describe various components, these components should not be limited by these terms. These terms are only used to distinguish one component from another. For example, without departing from the scope of the disclosure, the first component may be referred to as a second component, and similarly, the second component may also be referred to as a first component. Throughout this specification, when a portion is connected to another portion, this includes the case in which the portion is indirectly connected to the other portion, as well as the case in which the portion is directly connected to the other portion, and the indirect connection includes a connection through a wireless communication network.

Unless otherwise defined, all terms used in the disclosure (including technical and scientific terms) may be used in a sense that can be commonly understood by those skilled in the art to which embodiments of the disclosure belong. In addition, the terms defined in the commonly used dictionaries are not ideally or excessively interpreted unless they are specifically defined clearly. In addition, terms to be described below are terms defined in consideration of functions in the embodiments of the disclosure, and may vary according to user's or operators intention or custom. Therefore, the definition should be made based on the contents throughout the disclosure.

In the disclosure, “vehicle traffic lights” may refer to traffic lights for indicating a progress, stop, left turn or U-turn of a vehicle in the lane. In addition, “crosswalk traffic lights” may refer to traffic lights provided in a crosswalk for indicating the progress and stop of pedestrians. A “left lane” may refer to the left lane of a lane in which a host vehicle is positioned. A “right turn lane” may refer to the rightmost lane for making a right turn at the intersection. An “infrastructure device” may refer to a device having a communication module capable of vehicle to everything (V2X) communication with the host vehicle among devices such as vehicle traffic lights or crosswalk traffic lights installed at the intersection.

The disclosure may be applied to assist a driver of the vehicle when attempting the right turn at the intersection. In addition, the disclosure may be applied to an autonomous driving mode of an autonomous driving vehicle, within an applicable range.

Hereinafter, with reference to the accompanying drawings will be described a driving control apparatus, a method and a system of the vehicle according to embodiments of the disclosure.

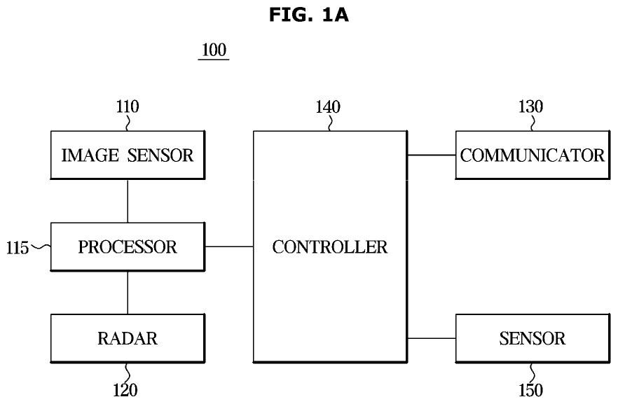

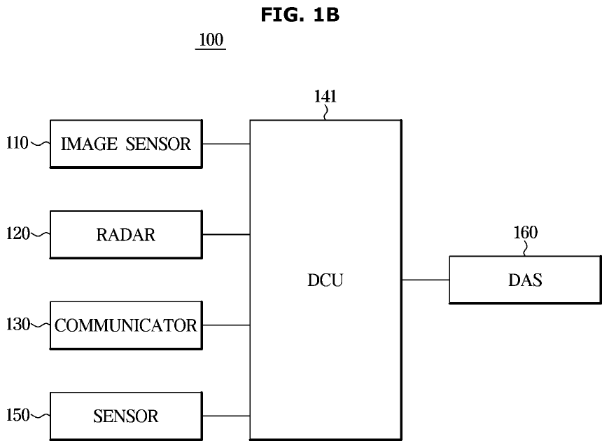

FIG. 1A is a block diagram of a driving control apparatus of a vehicle according to embodiments of the disclosure;

Referring to FIG. 1A, a driving control apparatus 100 of the vehicle may include an image sensor 110 disposed in the host vehicle so as to have a view of front of the host vehicle and configured to capture image data, a radar 120 disposed in the host vehicle so as to have a detecting area for the outside of the host vehicle configured to capture detecting data to detect surrounding objects, at least one processor 115 configured to process the image data captured by the image sensor 110 and the detecting data captured by the radar 120, a communicator 130 in wireless communication with at least one communication device external to the host vehicle, and a controller 140. The controller 140 may obtain state information of vehicle traffic lights from an image obtained based on the processing of the image data when a right turn operation is detected at the intersection based at least in part on the processing of the image data and the detecting data, and the state of the vehicle traffic lights. The controller 140 may control the host vehicle to turn right after pausing or decelerating at a predetermined speed based on state information of the vehicle traffic lights, information about another vehicle of the left lane detected through the radar 120, and state information of crosswalk traffic lights received through the communicator 130.

The image sensor 110 may be mounted at the front of the vehicle to obtain the image of a front field of view in units of frames. The image sensor 110 may be implemented as a complimentary metal-oxide semiconductor (CMOS) camera or a charge-coupled device (CCD) camera. However, as an example, the image sensor 110 is not limited to a specific type as long as the image sensor 110 may obtain the image of the front field of view.

The image sensor 110 may be disposed in the vehicle to have the view of the outside of the vehicle. At least one image sensor 110 may be mounted on each part of the vehicle to have the view of the front, side, or rear of the vehicle.

Since image information captured by the image sensor 110 is composed of the image data, the image information may refer to the image data captured by the image sensor 110. Hereinafter, in the disclosure, the image information captured by the image sensor 110 may refer to the image data captured by the image sensor 110. The image data captured by the image sensor 110 may be generated, for example, in one of AVI, MPEG-4, H.264, DivX, and JPEG in raw form. The image data captured by the image sensor 110 may be processed by the processor 115.

In addition, the image sensor 110 may be configured to capture the image data disposed in the host vehicle to have the field of view of the front of the host vehicle. The image data captured by the image sensor 110 may be processed by the processor 115 and used to obtain the state information of the vehicle traffic lights from the image obtained based on the processing of the image data when the right turn operation is detected at the intersection. The state information of the vehicle traffic lights, together with information about another vehicle of the left lane detected through the radar and state information of the crosswalk traffic lights received through the communicator 130, may be used to generate a control signal for controlling the host vehicle to turn right after pausing or decelerating at the predetermined speed.

The processor 115 may operate to process the image data captured by the image sensor 110. For example, at least a part of the detecting of a driving road and generating camera recognition information may be executed by the processor 115.

The processor 115 may be implemented using at least one of an electrical unit that may perform processing and other functions of the image data, such as application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and the like. In addition, the processor 115 may be implemented as one camera module together with the image sensor 110.

The radar 120 may transmit a radar signal and detect that the transmitted radar signal is reflected back to the object to provide information such as a distance to the object around the vehicle in units of frames. The radar 120 may include a transmission antenna for transmitting the radar signal and a receiving antenna for detecting the reflected radar signal. In the disclosure, the radar 120 is not limited to a particular radar, and embodiments of the disclosure may be applied substantially the same to any radar except when it is not applicable.

The radar 120 may include one or more of at least one radar sensor device, for example, a front detecting radar sensor mounted on the front of the vehicle, a rear detecting radar sensor mounted on the rear of the vehicle, and a lateral or lateral rear detecting radar sensor mounted on each side of the vehicle. The radar sensor or a radar system may analyze the transmitted signal and the received signal to process data, and accordingly may detect information about the object, and may include an electronic control unit (ECU) or the processor 115 for this purpose. The data transmission or signal communication from the radar sensor to the ECU may use a communication link, such as an appropriate vehicle network bus.

The radar sensor may include at least one transmission antenna for transmitting the radar signal and at least one receiving antenna for receiving the reflected signal received from the object.

On the other hand, the radar sensor may adopt signal transmission/reception schemes of a multi-dimensional antenna array and a multiple input multiple output to form a virtual antenna aperture larger than an actual antenna aperture.

For example, two-dimensional antenna arrays may be used to achieve horizontal and vertical angle precision and resolution. Using a two-dimensional radar antenna array, signals are transmitted and received by two separate scans (time multiplexed) horizontally and vertically, and MIMO can be used separately from two-dimensional radar horizontal and vertical scans (time multiplexed).

More particularly, the radar sensor may adopt the two-dimensional antenna array configuration consisting of a transmission antenna device including a total of 12 transmission antennas (Tx) and a receiving antenna device including a total of 16 receiving antennas (Rx). As a result, the radar sensor may be a total of 192 virtual receiving antenna arrangements.

In this case, the transmission antenna device may include three transmission antenna groups including four transmission antennas, wherein a first transmission antenna group may be spaced a predetermined distance from a second transmission antenna group in a vertical direction, and the first or second transmission antenna group may be spaced by a predetermined distance D from a third transmission antenna group in a horizontal direction.

Also, the receiving antenna device may include four receiving antenna groups including four receiving antennas, and each receiving antenna group may be arranged to be spaced vertically. The receiving antenna device may be disposed between the first transmission antenna group and the third transmission antenna group spaced apart in the horizontal direction.

In another embodiment, the antennas of the radar sensor may be arranged in the two-dimensional antenna array, for example, each antenna patch can have a Rhombus arrangement to reduce unnecessary side lobes.

Alternatively, the two-dimensional antenna array may include a V-shape antenna array in which a plurality of radiating patches are arranged in a V-shape, and more particularly, may include two V-shape antenna arrays. At this time, a single feed is made to an apex of each V-shape antenna array.

The two-dimensional antenna array may include an X-shape antenna array in which a plurality of radiation patches are arranged in an X-shape, and more particularly, may include two X-shaped antenna arrays. At this time, the single feed is made to a center of each X-shaped antenna array.

In addition, the radar sensor may use a MIMO antenna system in order to implement detecting accuracy or resolution in the vertical and horizontal directions.

In the MIMO system, each transmission antenna may transmit a signal having independent waveforms that are separated from each other. That is, each transmission antenna may transmit an independent waveform signal that is distinct from other transmission antennas, and each receiving antenna may determine in which transmission antenna the reflected signal reflected from the object is transmitted due to the different waveforms of the signals.

The radar sensor may include a radar housing for accommodating a substrate and a circuit including the transmission and receiving antenna, and a radome constituting an exterior of the radar housing. At this time, the radome may composed of a material that can reduce an attenuation of the radar signal transmitted and received. The radome may composed of the front and rear bumpers, grilles, side vehicle body or the exterior surfaces of the vehicle components.

That is, the radome of the radar sensor may be disposed inside the vehicle grille, the bumper, the vehicle body, or the like, and is disposed as a part of the parts constituting the exterior surface of the vehicle such as the vehicle grille, the bumper, the vehicle body part, thereby improving the vehicle aesthetics while providing the convenience of mounting the radar sensor.

The communicator 130 may perform vehicle-to-vehicle communication (V2V) between the host vehicle and another vehicle or vehicle-to-infrastructure communication (V2I) between the host vehicle and the infrastructure device. That is, through vehicle-to-everything communication (V2X), which is referred to as vehicle-to-vehicle communication or vehicle-to-infrastructure communication, the communicator may transmit and receive various information with another vehicle or infrastructure devices such as a current position of the vehicle, the speed, lighting state of the vehicle traffic lights and lighting state of the crosswalk traffic.

The communicator 130 may communicate with another vehicle or the infrastructure device within a communicable range. According to an example, the communication method of the V2X communication may be a multi hop network type, and may be a wireless access in vehicular environment (WAVE) communication method using a 59 Ghz communication frequency, but is not limited thereto. That is, an existing wireless communication protocol or a new wireless communication protocol may be used.

A V2X communication module included in the communicator 130 may be a module for performing wireless communication with a server or another vehicle. The V2X module may include a module capable of implementing the V2V or V2I protocol. The vehicle may perform wireless communication with an external server and another vehicle through the V2X communication module.

In vehicle-to-vehicle and vehicle-to-infrastructure telematic systems, the connected vehicles may interact with V2V, V2I) and V2X with each other, for example, through wireless communication. 3G/4G/5G cellular communication, Wi-Fi communication or 5.9 GHz Dedicated Short Range Communication (DSRC) may be used to provide the driver of the vehicle on the road with situational recognition, collision avoidance and post-accident assistance. The V2V/V2X communication systems may use telematics to wirelessly transmit data from a mounted host vehicle to another vehicle or the host vehicle or an infrastructure system (e.g., a traffic lights control system or a traffic management system). The data may be provided from one or more other vehicles or the infrastructure systems such as remote servers, and may telematically transmit to the vehicle. The data may include traffic conditions data, traffic density data, weather data, road condition data, and the like.

The controller 140 may control the overall operation of the driving control apparatus 100 of the vehicle. According to an example, the controller 110 may be implemented as the ECU. The controller 140 may receive a processing result of the image data and the detecting data from the processor 115 and process the image data and the detecting data. The controller 140 may control the right turn of the host vehicle at the intersection based at least in part on the processing of the image data and the detecting data.

The controller 140 may determine whether the right turn operation is detected at the intersection. The controller 140 may detect whether a driving lane of the host vehicle is a right turn lane from the image obtained by the image sensor 110. When the driving lane of the host vehicle is the right turn lane, the controller 140 may determine that there is the right turn operation when a right indicator of the host vehicle is turned on.

When the right turn operation is detected, the controller 140 may obtain the state information of vehicle traffic lights based on the image of the field of view obtained through the image sensor 110. The controller 140 may identify the lighting state of the vehicle traffic lights included in the image through image processing of the obtained image. When the lighting state of the vehicle traffic lights can be obtained from the image obtained through the image sensor 110, an image processing method is not limited to a specific method.

In addition, when the right turn operation is detected, the controller 140 may obtain information about another vehicle positioned in the left lane through the radar 120. The information about another vehicle may include information about the length, height or position of another vehicle. The controller 140 may request and receive information about a front image obtained from another vehicle or the pedestrian included in the front image through V2V communication with another vehicle.

When the right turn operation is detected, the controller 140 may receive the lighting state of the crosswalk traffic lights from the crosswalk traffic lights installed in the crosswalk that appeared before entering the intersection through V2X communication. Alternatively, the controller 140 may receive the lighting state of the crosswalk traffic lights from the crosswalk traffic lights installed in the crosswalk that appears when the right turn is made.

The controller 140 may control the host vehicle to turn right after pausing or decelerating at the predetermined speed based on the state information of the vehicle traffic lights, the information about another vehicle, and the state information of the crosswalk traffic lights. To this end, the controller 140 may transmit a signal for controlling at least one of an engine control electronic control unit, a braking electronic control unit, or a steering wheel electronic control unit.

That is, the controller 140 may control the engine control electronic control unit including an engine control unit for adjusting fuel injection according to an engine state and a driving state and a transmission control unit for an automatic transmission control in order to control the speed of the vehicle. In addition, the controller 140 may control the braking electronic control unit that adjusts a braking force of a hydraulic cylinder used in a hydraulic braking device or a braking motor used in an electronic braking device to adjust a braking distance of the vehicle. The controller 140 may control a steering wheel electronic control unit that controls a steering wheel to control a rotation of the vehicle.

The sensor 150 may include a plurality of sensors provided in the vehicle, and may detect driving information such as a vehicle speed and a steering angle of the vehicle and transmit the detected information to the controller 140. The sensor 150 may detect the lighting state of the turn indicator and transmit the detected state to the controller 140. However, this may be, for example, transmitting information about the lighting state from the turn indicator itself to the controller 140.

Accordingly, by controlling the driving of the host vehicle at the right turn according to the state information of the vehicle traffic lights, the information about another vehicle, and the state information of the crosswalk traffic lights, the right turn may be more safely performed at the intersection.

FIG. 1B is a block diagram of a driving control apparatus of a vehicle provided with a domain control unit (DCU) according to embodiments of the disclosure.

The driving control apparatus 100 of the vehicle the image sensor 110 disposed in the host vehicle so as to have the view of front of the host vehicle and configured to capture the image data, the radar 120 disposed in the host vehicle so as to have the detecting area for the outside of the host vehicle configured to capture the detecting data to detect surrounding objects, the communicator 130 in wireless communication with at least one communication device external to the host vehicle, and a domain control unit (DCU) 141 configured to process the image data captured by the image sensor 110 and the detecting data captured by the radar 120, and to control at least one driver assistance system provided in the vehicle.

The image sensor 110, the radar 120, the communicator 130, and the sensor 150 of the configuration of the driving control apparatus 100 of the vehicle illustrated in FIG. 1B may be substantially the same as the foregoing description of FIG. 1A except for the content that is not applicable, and a detailed description thereof will be omitted in order to avoid overlapping descriptions.

The DCU 141 may control the overall operation of the driving control apparatus 100 of the vehicle. The DCU 141 may receive the image data captured from at least one image sensor and receive the detecting data captured from a non-image sensor including at least one of the radar 120, a rider or an ultrasonic sensor to process at least one of the image data or the detecting data. The DCU 141 may include at least one processor for processing.

The DCU 141 may be provided in the vehicle to communicate with at least one image sensor and at least one non-image sensor mounted in the vehicle. To this end, a suitable data link or communication link may be further included, such as a vehicle network bus for data transmission or signal communication.

The DCU 141 may operate to control one or more of the various driver assistance systems (DAS) used in the vehicle. The DCU 141 may, based on the detecting data captured by the plurality of non-image sensors and the image data captured by the image sensor, control a driver assistance system (DAS) such as a blind spot detection (BSD) system, an adaptive cruise control (ACC) system, a lane departure warning system (LOWS), a lane keeping assistance system (LKAS), and a lane change assistance system (LCAS).

The DCU 141 may obtain the state information of the vehicle traffic lights from the mage obtained based on the processing of the image data when the right turn operation is detected at the intersection based at least in part on the processing of the image data and the detecting data. The DCU 141 may control the host vehicle to turn right after pausing or decelerating at the predetermined speed based on the state information of the vehicle traffic lights, the information about another vehicle of the left lane detected through the radar 120, and the state information of the crosswalk traffic lights received through the communicator 130.

The DCU 141 may determine whether the right turn operation is detected at the intersection. The DCU 141 may obtain the image by processing the image data captured by the image sensor 110. The DCU 141 may detect whether the driving lane of the host vehicle is the right turn lane from the obtained image. When the driving lane of the host vehicle is the right turn lane, the DCU 141 may determine that there is the right turn operation when the right indicator of the host vehicle is turned on.

When the right turn operation is detected, the DCU 141 may obtain the state information of the vehicle traffic lights based on the image of the field of view obtained through the image sensor 110. The DCU 141 may identify the lighting state of the vehicle traffic lights included in the image through image processing of the obtained image. When the lighting state of the vehicle traffic lights can be obtained from the image obtained through the image sensor 110, an image processing method is not limited to the specific method.

In addition, when the right turn operation is detected, the DCU 141 may obtain information about another vehicle positioned in the left lane through the radar 120. The information about another vehicle may include information about the length, height or position of another vehicle. The DCU 141 may request and receive information about a front image obtained from another vehicle or the pedestrian included in the front image through V2V communication with another vehicle.

When the right turn operation is detected, the DCU 141 may receive the lighting state of the crosswalk traffic lights from the crosswalk traffic lights installed in the crosswalk that appeared before entering the intersection through V2X communication. Alternatively, the DCU 141 may receive the lighting state of the crosswalk traffic lights from the crosswalk traffic lights installed in the crosswalk that appears when the right turn is made.

The DCU 141 may control the host vehicle to turn right after pausing or decelerating at the predetermined speed based on the state information of the vehicle traffic lights, the information about another vehicle, and the state information of the crosswalk traffic lights. To this end, the DCU 141 may transmit the signal for controlling at least one of the engine control electronic control unit, the braking electronic control unit, or the steering wheel electronic control unit.

That is, the DCU 141 may control the engine control electronic control unit including the engine control unit for adjusting fuel injection according to the engine state and the driving state and a transmission control unit for the automatic transmission control in order to control the speed of the vehicle. In addition, the DCU 141 may control the braking electronic control unit that adjusts the braking force of the hydraulic cylinder used in the hydraulic braking device or the braking motor used in the electronic braking device to adjust the braking distance of the vehicle.

Accordingly, by controlling the driving of the host vehicle at the right turn according to the state information of the vehicle traffic lights, the information about another vehicle, and the state information of the crosswalk traffic lights, the right turn may be more safely performed at the intersection.

Hereinafter, a detailed operation of the driving control apparatus 100 of the vehicle according to the state information of the vehicle traffic lights, the information about another vehicle, and the state information of the crosswalk traffic lights will be described with reference to related drawings. Hereinafter, although described with reference to the controller 140, it is not limited thereto. The operation of the controller 140 may be substantially performed in the DCU 141 as long as it does not contradict.

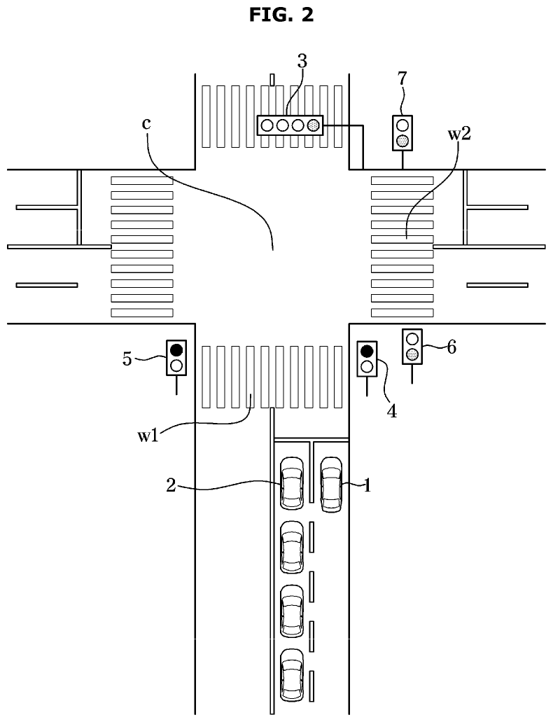

FIGS. 2 to 6 are views for describing controlling right turn driving according to states of vehicle traffic lights, crosswalk traffic lights, and another vehicle in an intersection according to embodiments of the disclosure.

Referring to FIG. 2, in the intersection c, a situation where a host vehicle 1 is driving on the right turn lane is illustrated. Another vehicle 2 may be positioned in the left lane of the host vehicle 1. It is assumed that the lighting state of a vehicle traffic lights 3 representing traffic signals related to the driving of the host vehicle 1 is green (illustrated in dot pattern, the same also in the following drawings). Since the vehicle traffic lights 3 is turned on in green, crosswalk traffic lights 4 and 5 installed in correspondence with a crosswalk w1 appearing before entering the intersection c is turned on in red (illustrated in black, the same also in the following drawings).

The controller 140 may detect the lane in the front image obtained through the image sensor 110 and determine whether the right turn lane is being driven. The detection method of the lane in the image is not limited to the specific method as long as the detection of the lane is possible. The operation of determining whether it is the right turn lane may be started when the intersection c is approached within the predetermined distance. According to an example, the controller 140 may determine whether the host vehicle 1 approaches the intersection c within the predetermined distance based on map information stored in a separate memory or navigation information received through the communicator 130.

When the host vehicle 1 approaches the intersection c along the right turn lane within the predetermined distance, the controller 140 may identify whether the right indicator is turned on. When the right indicator is turned on, the controller 140 may determine that the right turn operation is detected.

The controller 140 may process the front image obtained through the image sensor 110 to obtain information about the lighting state of the vehicle traffic lights 3. When the lighting state of the vehicle traffic lights 3 can be confirmed in the image, the image processing method is not limited to the specific method.

When the vehicle traffic lights 3 identified in the image is green, the straight driving vehicles in the left lane drive straight, and the crosswalk traffic lights 4 and 5 of the crosswalk w1 before entering the intersection c is red. Therefore, the host vehicle 1 may drive by turning right.

According to an example, when the vehicle traffic lights 3 is green, the controller 140 may control the host vehicle 1 to decelerate at the predetermined speed and turn right. For example, the predetermined speed may be set to 30 km/h to enable the driver to respond in a sudden situation. However, this is only an example, and the disclosure is not limited thereto. If necessary, the predetermined speed may be set differently. When the current speed of the host vehicle 1 is slower than the predetermined speed, the controller 140 may control to maintain the current speed.

The controller 140 may identify whether the pedestrian is detected at the crosswalk w1 based on the image obtained by the image sensor 110 even when the vehicle traffic lights 3 is turned on in green. This is to prevent accidents caused by the pedestrian attempting unauthorized crossing even when the lighting of the crosswalk w1 is red. When the pedestrian is detected, the controller 140 may control to pause the pedestrian while passing the driving path.

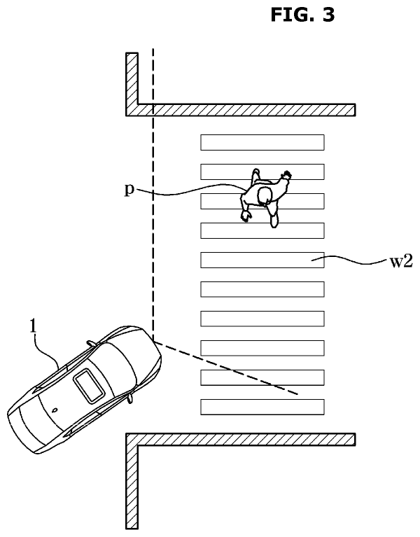

In addition, when the host vehicle 1 turns to the right while the vehicle traffic lights 3 is turned on in green, the controller 140 may identify whether a pedestrian p is detected at a crosswalk w2 as illustrated in FIG. 3. This is to prevent accidents caused by the pedestrian when the lighting of the crosswalk w2 is green or the pedestrian attempting unauthorized crossing when the lighting of the crosswalk w2 is red. When the pedestrian is detected, the controller 140 may control to pause the pedestrian while passing the driving path.

According to another example, the controller 140 may identify the lighting state of the crosswalk traffic lights 7 in the front image when the host vehicle 1 turns right while the vehicle traffic lights 3 is turned on in green. Alternatively, the controller 140 may receive lighting state information from at least one of the crosswalk traffic lights 6 and 7 disposed in the crosswalk w2 through the communicator 130. When the lighting state of the crosswalk traffic lights 6 and 7 is green, the controller 140 may pause and control to maintain or stop a stop mode according to whether the pedestrian p is detected.

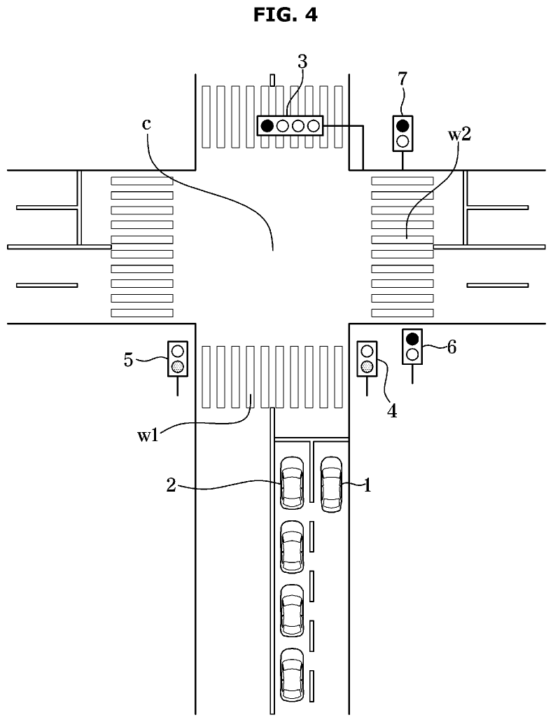

Referring to FIG. 4, in the intersection c, a situation where a host vehicle 1 is driving on the right turn lane is illustrated. Another vehicle 2 may be positioned in the left lane of the host vehicle 1. Unlike FIG. 2, it is assumed that the lighting state of the vehicle traffic lights 3 is red. According to an example, even if the lighting state of the vehicle traffic lights 3 is yellow, the following description may be equally applied.

When the host vehicle 1 approaches the intersection c within the predetermined distance, the controller 140 may determine whether the right turn operation is detected. When the right turn operation is detected, the controller 140 may process the front image obtained through the image sensor 110 to obtain information about the lighting state of the vehicle traffic lights 3. When the lighting state of the vehicle traffic lights 3 can be confirmed in the image, the image processing method is not limited to the specific method.

When the vehicle traffic lights 3 identified in the image is red or yellow, the vehicle traffic lights 3 for the road crossing the driving road of the host vehicle 1 may be turned on in green. When the vehicle traffic lights 3 is red or yellow, the crosswalk traffic lights 4 and 5 of the crosswalk w1 before entering the intersection c may be green or red.

The controller 140 may control the host vehicle 1 to pause when the vehicle traffic lights 3 is red or yellow. The controller 140 may detect a stop line in the front image and control to pause in front of the stop line.

When the vehicle traffic lights 3 is turned on red or yellow, the controller 140 may receive the lighting state information from at least one of the crosswalk traffic lights 4 and 5 disposed in the crosswalk w1 positioned before entering the intersection c through the communicator 130. When the lighting state of the crosswalk traffic lights 4 and 5 is green, the controller 140 may control to maintain the stop state of the host vehicle 1 until the lighting state of the crosswalk traffic lights 4 and 5 is red.

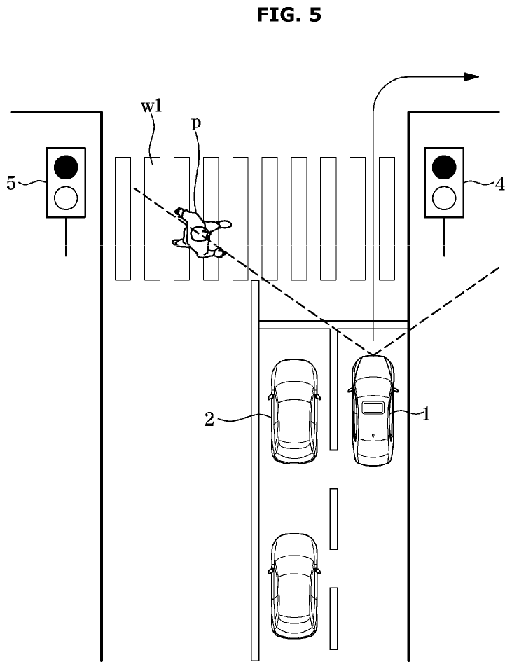

Referring to FIG. 5, the lighting state of the crosswalk traffic lights 4 and 5 is changed to red. When the lighting state of the crosswalk traffic lights 4 and 5 is changed to red, the controller 140 may receive information about the change of the lighting state from at least one of the crosswalk traffic lights 4 and 5.

The controller 140 may identify whether the pedestrian p is detected at the crosswalk w1 based on the image obtained by the image sensor 110. This is to prevent accidents caused by the pedestrian attempting unauthorized crossing even when the lighting of the crosswalk w1 is red. When the pedestrian p is detected, the controller 140 may control to pause the pedestrian p while passing the driving path.

When no the pedestrian p is detected, the controller 140 may control the host vehicle 1 to turn right at the predetermined speed. For example, the predetermined speed may be set to 30 km/h to enable the driver to respond in the sudden situation. However, this is only an example, and the disclosure is not limited thereto. If necessary, the predetermined speed may be set differently.

When the host vehicle 1 turns right, the controller 140 may identify whether the pedestrian p is detected at the crosswalk w2 as illustrated in FIG. 3. This is to prevent accidents caused by the pedestrian attempting unauthorized crossing even when the lighting of the crosswalk w2 is red. When the pedestrian p is detected, the controller 140 may control to pause the pedestrian p while passing the driving path.

According to another example, the controller 140 may identify the lighting state of the crosswalk traffic lights 7 in the front image when the host vehicle 1 turns right. Alternatively, the controller 140 may receive lighting state information from at least one of the crosswalk traffic lights 6 and 7 disposed in the crosswalk w2 through the communicator 130. When the lighting state of the crosswalk traffic lights 6 and 7 is green, the controller 140 may pause and control to maintain or stop a stop mode according to whether the pedestrian p is detected.

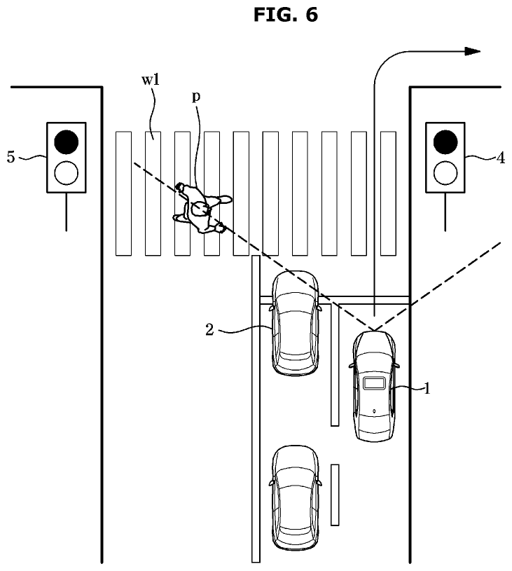

Referring to FIG. 6, when the vehicle traffic lights 3 is red or yellow, another vehicle 2 in the left lane is stopped closer to the crosswalk w1 than the host vehicle 1. In this case, the left side of the front image obtained by the image sensor 110 of the host vehicle 1 may be in a state of being covered by another vehicle 2. Therefore, the pedestrian p may not appear in the front image obtained from the host vehicle 1.

The controller 140 may determine whether a portion of the front image is covered by another vehicle 2 using information about another vehicle 2 detected through the radar 120. The controller 140 may determine whether another vehicle 2 exists in the field of view of the image sensor 110 in relation to the host vehicle 1 using information such as the position and size of another vehicle 2. Alternatively, the controller 140 may detect whether another vehicle 2 is included in a left area by performing image processing on the front image.

According to an example, the controller 140 may determine whether V2V communication with another vehicle 2 is possible when the pedestrian p is not detected while the left area in the front image is covered by another vehicle 2. The controller 140 may request V2V communication from another vehicle 2 through the communicator 130.

According to an example, when there is no response from the request from another vehicle 2 or when V2V communication is not possible, the controller 140 may control the host vehicle 1 to turn right at the predetermined speed while outputting an alert for the appearance of the pedestrian from the left side. The driving control apparatus 100 of the vehicle may further include an output device including at least one of a display, a speaker, and a haptic module. The output device may output a visual alert through the display, output an audible alert through the speaker, or output a tactile alert through the haptic module to inform that the pedestrian may appear from the left side. Accordingly, the driver may turn the vehicle right at the predetermined speed while preparing for the situation in which the pedestrian suddenly appears on the left side.

According to an example, when there is the response to the V2V communication from another vehicle 2, the controller 140 may request front image information obtained from a front camera of another vehicle 2. Alternatively, the controller 140 may request information about whether the pedestrian is detected in the front image by another vehicle 2.

When no the pedestrian is detected in the front image of another vehicle 2, the controller 140 may control the host vehicle 1 to turn right at the predetermined speed. When the pedestrian is detected in the front image of another vehicle 2, the controller 140 may control to maintain the stop state until the pedestrian p passes the driving path of the host vehicle 1.

Accordingly, by controlling the driving of the host vehicle 1 at the right turn according to the state information of the vehicle traffic lights 3, the information about another vehicle 2, and the state information of the crosswalk traffic lights 6 and 7, the right turn may be more safely performed at the intersection.

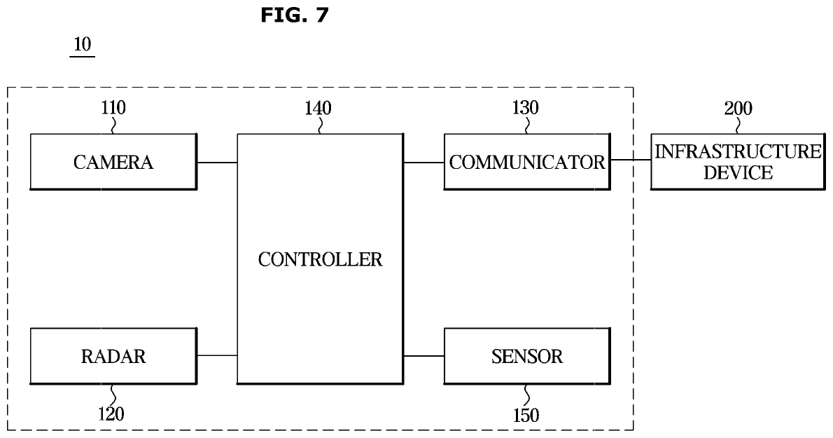

FIG. 7 is a block diagram of a driving control system of a vehicle according to embodiments of the disclosure.

Referring to FIG. 7, a driving control system 10 of the vehicle may include the driving control apparatus 100 of the vehicle including an infrastructure device 200 that includes the vehicle traffic lights and the crosswalk traffic lights, a camera 110 configured to capture the front image of the host vehicle, the radar 120 configured to capture the object around the host vehicle, the communicator 130 in wireless communication with the communication device provided in the infrastructure device 200, and the controller 140. The controller 140 may obtain the state information of the vehicle traffic lights from the image when the right turn operation is detected at the intersection, and may control the host vehicle to turn right after pausing or decelerating at the predetermined speed based on the state information of the vehicle traffic lights, the information about another vehicle of the left lane detected through the radar 120, and the state information of the crosswalk traffic lights received from the infrastructure device 200.

Since the driving control apparatus 100 of the vehicle is substantially the same as the content described with reference to FIG. 1, the detailed description thereof will be omitted in order to avoid duplication of description. According to an example, the camera 110 may be implemented as one module including the image sensor and the processor described above.

The infrastructure device 200 may include various devices that are installed around the intersection to provide information about the traffic signal or a pedestrian signal at the intersection and information about the movement of the vehicles to the vehicle through the communication device. For example, the vehicle traffic lights and the crosswalk traffic lights have been described above, but are not limited thereto. When the host vehicle is provided with the device capable of transmitting related information, the infrastructure device 200 may include road signs, street lights, and various other information providing devices.

In addition, the infrastructure device 200 may include the server connected to the information providing device installed in the vicinity of the intersection by a network. For example, when information related to the host vehicle, such as the server of a traffic management system, a navigation information providing server, or the like can be provided, the server of the infrastructure apparatus 200 is not limited to a specific server.

As described above, the controller 140 included in the driving control apparatus 100 of the vehicle may control the right turn of the vehicle at the intersection based on the information received through the communicator 130 from the infrastructure device 200, such as the crosswalk traffic lights, in addition to the various information obtained through the camera 110, the radar 120, and the sensor 150.

The right turn of the host vehicle is controlled by using information obtained from the infrastructure device 200 such as the vehicle traffic lights or the crosswalk traffic lights in addition to the information obtained from the host vehicle, so that the right turn can be performed more safely and reliably at the intersection.

A driving control method of the vehicle according to the disclosure may be implemented in the driving control apparatus 100 of the vehicle described above. Hereinafter, the driving control method of the vehicle and the operation of the driving control apparatus 100 of the vehicle for implementing the same will be described in detail with reference to the accompanying drawings.

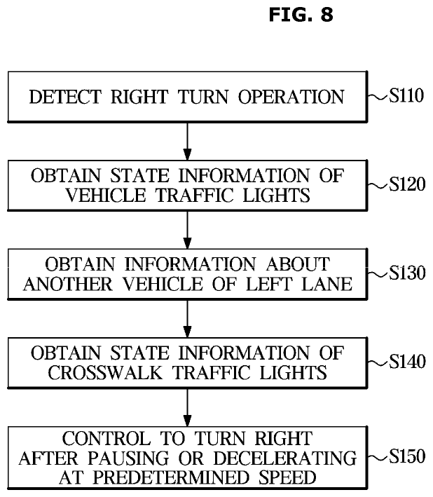

FIG. 8 is a flowchart illustrating a driving control method of a vehicle according to embodiments of the disclosure.

Referring to FIG. 8, the driving control apparatus 100 of the vehicle may detect the right turn operation at the intersection (S110).

The controller 140 of the driving control apparatus 100 of the vehicle may determine whether the right turn operation is detected at the intersection. The controller 140 may detect whether the driving lane of the host vehicle is the right turn lane from the image obtained by the camera 110. When the driving lane of the host vehicle is the right turn lane, the controller 140 may determine that there is the right turn operation when the right indicator of the host vehicle is turned on.

The driving control apparatus 100 of the vehicle may obtain the state information of the vehicle traffic lights from the front image of the host vehicle (S120).

When the right turn operation is detected, the controller 140 of the driving control apparatus 100 of the vehicle may obtain the state information of the vehicle traffic lights based on the image of the field of view obtained through the camera 110. The controller 140 may identify the lighting state of the vehicle traffic lights included in the image through image processing of the obtained image.

The driving control apparatus 100 of the vehicle may obtain the information about another vehicle of the left lane detected through the radar 120 (S130).

When the right turn operation is detected, the controller 140 of the driving control apparatus 100 of the vehicle may obtain the information about another vehicle positioned in the left lane through the radar 120. The information about another vehicle may include information about the length, height or position of another vehicle.

The driving control apparatus 100 of the vehicle may obtain the state information of the crosswalk traffic lights from the communication device outside the host vehicle (S140).

When the right turn operation is detected, the controller 140 of the driving control apparatus 100 of the vehicle may receive the lighting state of the crosswalk traffic lights from the crosswalk traffic lights installed in the crosswalk that appeared before entering the intersection through the V2X communication. Alternatively, the controller 140 may receive the lighting state of the crosswalk traffic lights from the crosswalk traffic lights installed in the crosswalk that appears when the right turn is made.

In FIG. 8, operations S120 to S140 are illustrated in order, but this is not limited to the illustrated order as an example. The operations S120 to S140 may be performed at the same time when the right turn operation is detected, or may be performed in a reversed order.

Referring back to FIG. 8, the driving control apparatus 100 of the vehicle may control the host vehicle to turn right after pausing or decelerating at the predetermined speed based on the state information of the vehicle traffic lights, the information about another vehicle, and the state information of the crosswalk traffic lights (S150).

The controller 140 of the driving control apparatus 100 of the vehicle may control the host vehicle to turn right after pausing or decelerating at the predetermined speed based on the state information of the vehicle traffic lights, the information about another vehicle, and the state information of the crosswalk traffic lights. To this end, the controller 140 may transmit the signal for controlling at least one of the engine control electronic control unit, the braking electronic control unit, or the steering wheel electronic control unit.

That is, the controller 140 may control the engine control electronic control unit including the engine control unit for adjusting fuel injection according to the engine state and the driving state and the transmission control unit for the automatic transmission control in order to control the speed of the vehicle. In addition, the controller 140 may control the braking electronic control unit that adjusts the braking force of the hydraulic cylinder used in the hydraulic braking device or the braking motor used in the electronic braking device to adjust the braking distance of the vehicle.

The plurality of sensors 150 included in the driving control apparatus 100 of the vehicle may detect driving information such as the vehicle speed and the steering angle of the vehicle and transmit the detected information to the controller 140. The sensor 150 may detect the lighting state of the turn indicator and transmit the detected state to the controller 140. However, this may be, for example, transmitting information about the lighting state from the turn indicator itself to the controller 140.

Accordingly, by controlling the driving of the host vehicle at the right turn according to the state information of the vehicle traffic lights, the information about another vehicle, and the state information of the crosswalk traffic lights, the right turn may be more safely performed at the intersection.

Hereinafter, the driving control method of the vehicle according to the state information of the vehicle traffic lights, the information about another vehicle, and the state information of the crosswalk traffic lights will be described in detail with reference to the related drawings.

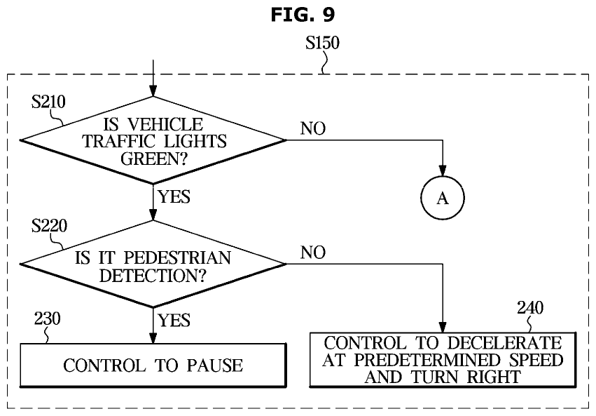

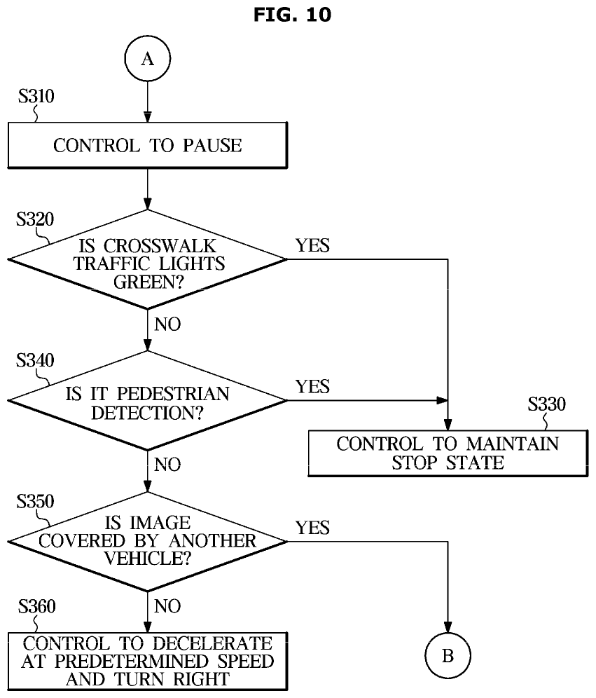

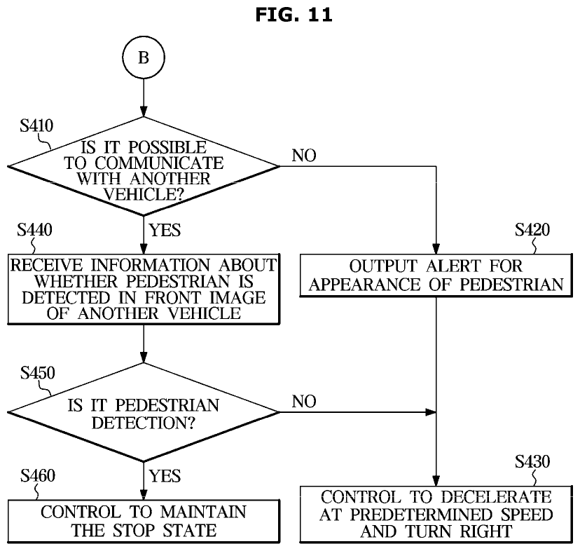

FIG. 9 is a flowchart illustrating a method of controlling right turn driving when green is turned on in vehicle traffic lights according to embodiments of the disclosure, FIG. 10 is a flowchart illustrating a method of controlling right turn driving when red or yellow are turned on in vehicle traffic lights according to embodiments of the disclosure, and FIG. 11 is a flowchart illustrating a method of controlling right turn driving when an image is covered by another vehicle positioned in a left lane according to embodiments of the disclosure.

FIGS. 9 to 11 are assumed that the operations S110 to S140 described with reference to FIG. 8 are performed, and thus a redundant description will be omitted, and the method of controlling the host vehicle for operation S150 will be described in detail.

The controller 140 of the driving control apparatus 100 of the vehicle may detect the lane from the front image obtained through the camera 110 and determine whether the vehicle is driving the right turn lane. The operation of determining whether it is the right turn lane may be started when the intersection approaches the predetermined distance.

The controller 140 may identify whether the right indicator is turned on when the host vehicle approaches the intersection within the predetermined distance along the right turn lane. When the right indicator is turned on, the controller 140 may determine that the right turn operation is detected.

Referring to FIG. 9, the controller 140 may identify the information about the lighting state of the vehicle traffic lights by processing the front image obtained through the camera 110 (S210).

When the vehicle traffic lights identified from the vehicle image is green, the driving vehicles in the left lane drive straight and the crosswalk traffic lights of the crosswalk before entering the intersection is red, so the host vehicle may drive right.

According to an example, when the vehicle traffic lights is green (YES in S210), the controller 140 may control the host vehicle to decelerate at the predetermined speed and turn right. For example, the predetermined speed may be set to 30 km/h to enable the driver to respond in a sudden situation. However, this is only an example, and the disclosure is not limited thereto. If necessary, the predetermined speed may be set differently. When the current speed of the host vehicle is slower than the predetermined speed, the controller 140 may control to maintain the current speed.

When the host vehicle turns to the right while the vehicle traffic lights is turned on in green, the controller 140 may identify whether the pedestrian is detected in the crosswalk that appears when the right turn is made (S220). This is to prevent accidents caused by the pedestrian when the lighting of the crosswalk is green or the pedestrian attempting unauthorized crossing when the lighting of the crosswalk is red. When the pedestrian is detected (YES in S220), the controller 140 may control to pause the pedestrian while passing the driving path (S230).

According to another example, the controller 140 may identify the lighting state of the crosswalk traffic lights in the front image when the host vehicle turns right while the vehicle traffic lights is turned on in green. Alternatively, the controller 140 may receive lighting state information from at least one of the crosswalk traffic lights disposed in the crosswalk through the communicator 130. When the lighting state of the crosswalk traffic lights is green, the controller 140 may pause and control to maintain or stop the stop mode according to whether the pedestrian is detected.

Returning to operation S210, when the lighting state of the vehicle traffic lights is red or yellow (NO in S210), referring to FIG. 10, the controller 140 of the driving control apparatus 100 of the vehicle may control the host vehicle to pause (S310). The controller 140 may detect the stop line in the front image and control to pause in front of the stop line.

When the vehicle traffic lights is turned on red or yellow, the controller 140 may receive the lighting state information from at least one of the crosswalk traffic lights disposed in the crosswalk positioned before entering the intersection through the communicator 130. When the lighting state of the crosswalk traffic lights is green, the controller 140 may control to maintain the stop state of the host vehicle until the lighting state of the crosswalk traffic lights is red (S330).

Then, when the lighting state of the crosswalk traffic lights is changed to red (NO in S320), the controller 140 may receive the information about the change of the lighting state from at least one of the crosswalk traffic lights. The controller 140 may identify whether the pedestrian is detected at the crosswalk based on the image obtained by the camera 110 (S340). This is to prevent accidents caused by the pedestrian attempting unauthorized crossing even when the lighting of the crosswalk is red. When the pedestrian is detected, the controller 140 may control to pause the pedestrian while passing the driving path (S330).

When no pedestrian is detected (NO in S340), the controller 140 may determine whether the left side of the front image obtained by the camera 110 of the host vehicle is covered by another vehicle (S350). The controller 140 may determine whether the portion of the front image is covered by another vehicle using the information about another vehicle detected through the radar 120. The information such as the position and size of another vehicle can be used to determine whether another vehicle exists in the field of view of the camera 110 in relation to the host vehicle. Alternatively, the controller may detect whether another vehicle is included in the left area by performing image processing on the front image.

When the left area in the front image is not covered by another vehicle (NO in S350), the controller 140 may control the host vehicle to decelerate at the predetermined speed and turn right (S360).

When the left area in the front image is covered by another vehicle (YES in S350), referring to FIG. 11, the controller 140 may identify whether V2V communication with another vehicle is possible (S410). The controller 140 may request V2V communication from another vehicle through the communicator 130.

According to an example, when there is no response from the request from another vehicle or when V2V communication is not possible (NO in S410), the controller 140 may control the host vehicle to turn right at the predetermined speed while outputting the alert for the appearance of the pedestrian from the left side (S420, S430). The driving control apparatus 100 of the vehicle may further include the output device including at least one of the display, the speaker, and the haptic module. The output device may output the visual alert through the display, output the audible alert through the speaker, or output the tactile alert through the haptic module to inform that the pedestrian may appear from the left side. Accordingly, the driver may turn the vehicle right at the predetermined speed while preparing for the situation in which the pedestrian suddenly appears on the left side.

When there is the response to the V2V communication from another vehicle (YES in S410), the controller 140 may request the front image information obtained from the front camera of another vehicle. Alternatively, the controller 140 may request information about whether the pedestrian is detected in the front image by another vehicle (S440).

When no the pedestrian is detected in the front image of another vehicle (NO in S450), the controller 140 may control the host vehicle to turn right at the predetermined speed (S430). When the pedestrian is detected in the front image of another vehicle (YES in S450), the controller 140 may control to maintain the stop state until the pedestrian passes the driving path of the host vehicle 1 (S460).

Accordingly, by controlling the driving of the host vehicle at the right turn according to the state information of the vehicle traffic lights, the information about another vehicle, and the state information of the crosswalk traffic lights, the right turn may be more safely performed at the intersection.

The disclosure described above may be embodied as computer-readable codes on a medium in which a program is recorded. The computer-readable medium includes all kinds of recording devices in which data that may be read by a computer system is stored. Examples of computer-readable media include hard disk drives (HDDs), solid state disks (SSDs), silicon disk drives (SDDs), ROMs, RAMs, CD-ROMs, magnetic tapes, floppy disks, optical data storage devices, and the like, and also include those implemented in the form of a carrier wave (for example, transmission over the Internet).

According to an aspect of the disclosure as described above, it is possible to provide the driving control apparatus of the vehicle capable of performing the right turn more safely in the intersection by controlling the driving of the host vehicle during the right turn according to state information of vehicle traffic lights, information of another vehicle, and state information of crosswalk traffic lights, and the method and the system thereof.

The description above and the accompanying drawings are merely illustrative of the technical spirit of the disclosure, and a person of ordinary skill in the art to which the disclosure pertains will be able to make various modifications and variations such as combining, separating, substituting and changing the configurations without departing from the essential characteristics of the disclosure. Accordingly, the disclosed embodiments are not intended to limit the technical spirit of the disclosure but to describe the scope of the technical spirit of the disclosure. That is, within the scope of the disclosure, all of the components may be operated in a selective combination with one or more. The protection scope of the disclosure should be interpreted by the following claims, and all technical ideas within the scope equivalent thereto shall be construed as being included in the scope of the disclosure.

What is claimed is:

1. An apparatus for assisting driving of a vehicle comprising:
an image sensor disposed in the vehicle to have a field of view of the front of the vehicle, configured to capture image data;
a radar disposed in the vehicle to have a detecting area the outside of the vehicle, configured to capture detecting data to detect an object around the vehicle; and
a controller including at least one processor configured to process the image data captured by the image sensor and the detecting data captured by the radar,
wherein the controller is configured to:
obtain state information of vehicle traffic lights based on processing of the image data, in response to a right turn operation is detected at an intersection; and
control the vehicle to turn right after pausing or decelerating at a predetermined speed based on the state information of the vehicle traffic lights, information about another vehicle of a left lane detected based on processing of the detecting data, and state information of crosswalk traffic lights received from an external device.

2. The apparatus according to claim 1, wherein the controller is configured to detect the right turn operation, in response to a driving lane of the vehicle detected based on the processing of the image data is a right turn lane and a right indicator of the vehicle is turned on.

3. The apparatus according to claim 1, wherein the controller is configured to control the vehicle to decelerate at the predetermined speed and turn right in response to the vehicle traffic lights is green.

4. The apparatus according to claim 3, wherein the controller is configured to control the vehicle to pause in response to a pedestrian is detected based on the processing of the image data at a right turn.

5. The apparatus according to claim 1, wherein the controller is configured to control the vehicle to pause in response to the vehicle traffic lights is red or yellow.

6. The apparatus according to claim 5, wherein the controller is configured to control the vehicle to maintain a stop state in response to the crosswalk traffic lights of a crosswalk positioned before entering the intersection is green.

7. The apparatus according to claim 5, wherein the controller is configured to:
control the vehicle to maintain a stop state in response to a pedestrian is detected based on the processing of the image data, when the crosswalk traffic lights of a crosswalk positioned before entering the intersection is red; and
control the vehicle to turn right at the predetermined speed in response to the pedestrian is not detected.

8. The apparatus according to claim 7, wherein the controller is configured to control the vehicle to turn right at the predetermined speed while outputting an alert for an appearance of the pedestrian from a left side, in response to the pedestrian is not detected while a left area of an image corresponding to the image data is covered by the another vehicle.

9. The apparatus according to claim 7, wherein the controller is configured to receive information about whether the pedestrian is detected in a front image of the another vehicle from the another vehicle, in response to a left area of an image corresponding to the image data is covered by the another vehicle.

10. A method for assisting driving of a vehicle comprising:
obtaining image data through a camera disposed in the vehicle to have a field of view of the outside of the vehicle;
obtaining detecting data through a radar disposed in the vehicle to have a detecting area of the outside of the vehicle;
detecting a right turn operation at an intersection;
obtaining state information of vehicle traffic lights based on processing of the image data;
obtaining information about another vehicle of a left lane detected based on processing of the detecting data;
receiving state information of crosswalk traffic lights from a communication device of the outside of the vehicle; and
controlling the vehicle to turn right after pausing or decelerating at a predetermined speed based on the state information of the vehicle traffic lights, the information about the another vehicle, and the state information of the crosswalk traffic lights.

11. The method according to claim 10, wherein the detecting of the right turn operation at the intersection comprises:
detecting the right turn operation, in response to a driving lane of the vehicle detected based on the processing of the image data is a right turn lane and a right indicator of the vehicle is turned on.

12. The method according to claim 10, wherein the controlling of the vehicle comprises:
controlling the vehicle to decelerate at the predetermined speed and turn right in response to the vehicle traffic lights is green.

13. The method according to claim 12, wherein the controlling of the vehicle comprises:
controlling the vehicle to pause in response to a pedestrian is detected based on the processing of the image data at a right turn.

14. The method according to claim 10, wherein the controlling of the vehicle comprises:
controlling the vehicle to pause in response to the vehicle traffic lights is red or yellow.

15. The method according to claim 14, wherein the controlling of the vehicle comprises:
controlling the vehicle to maintain a stop state in response to the crosswalk traffic lights of a crosswalk positioned before entering the intersection is green.

16. The method according to claim 14, wherein the controlling of the vehicle comprises:
controlling the vehicle to maintain a stop state in response to a pedestrian is detected based on the processing of the image data, when the crosswalk traffic lights of a crosswalk positioned before entering the intersection is red; and
controlling the vehicle to turn right at the predetermined speed in response to the pedestrian is not detected.

17. The method according to claim 16, wherein the controlling of the vehicle comprises:
controlling the vehicle to turn right at the predetermined speed while outputting an alert for an appearance of the pedestrian from a left side, in response to the pedestrian is not detected while a left area of an image corresponding to the image data is covered by the another vehicle.

18. The method according to claim 16, further comprising:
receiving information about whether the pedestrian is detected in a front image of the another vehicle from the another vehicle, in response to a left area of an image corresponding to the image data is covered by the another vehicle.

19. An apparatus for assisting driving of a vehicle comprising:
an image sensor disposed in the vehicle to have a field of view of the front of the vehicle, configured to capture image data;
a radar disposed in the vehicle to have a detecting area the outside of the vehicle, configured to capture detecting data to detect an object around the vehicle; and
a domain control unit (DCU) configured to process the image data captured by the image sensor and the detecting data captured by the radar, and to control at least one driver assistance system provided in the vehicle,
wherein the DCU is configured to:
obtain state information of vehicle traffic lights based on processing of the image data, in response to a right turn operation is detected at an intersection based on at least one of the image data and the detecting data; and
control the vehicle to turn right after pausing or decelerating at a predetermined speed based on the state information of the vehicle traffic lights, information about another vehicle of a left lane detected through the radar, and state information of crosswalk traffic lights received from an external device.

20. The apparatus according to claim 19, wherein the DCU is configured to control the vehicle to decelerate at the predetermined speed and turn right in response to the vehicle traffic lights is green.
